(19) United States
(12) Patent Application Publication
(10) Pub. No.: US 2016/0033284 A1
(43) Pub. Date: Feb. 4, 2016

(54) POSITION CALCULATION METHOD AND POSITION CALCULATION DEVICE

(71) Applicant: Seiko Epson Corporation, Tokyo (JP)

(72) Inventor: Akinobu SATO, Fujimi-machi (JP)

(21) Appl. No.: 14/811,000

(22) Filed: Jul. 28, 2015

(30) Foreign Application Priority Data
Jul. 31, 2014 (JP) 2014-156117

(51) Int. Cl. G01C 21/20; G01C 21/16

(52) U.S. Cl. CPC G01C 21/20; G01C 21/16

(57) ABSTRACT

In a position calculation device, an inertial navigation arithmetic unit calculates the position, the velocity, and the posture angle of the device by performing inertial navigation arithmetic using a detection value of an IMU, and a Kalman filter unit presumptively calculates the position, the velocity, the posture angle, or the like of the device by performing Kalman filter processing using an arithmetic result of the inertial navigation arithmetic unit. In addition, a KF initial parameter setting unit sets an initial value of an error covariance matrix which is an error index value used in the Kalman filter processing according to a difference with respect to an environment of the previous use.

### BACKGROUND

1. Technical Field

The invention relates to a position calculation device or the like using a detection result of a sensor for position calculation.

2. Related Art

Inertial navigation arithmetic which autonomously calculates the position, the velocity, the posture angle, or the like of a movable body by using detection results of various sensors such as an acceleration sensor or a gyro sensor has been widely used. In an output value of the sensor, a bias (an error) represented by a zero point bias is included, and a large error may occur due to the bias in an inertial navigation arithmetic result. For this reason, it is necessary to perform calibration of calculating (estimating) the bias of the sensor before starting the inertial navigation arithmetic (for example, refer to JP-A-2012-8096).

In the bias of the sensor, a turn-on bias which is generated at the time of activating a power source, and a random drift due to an external factor such as a power fluctuation or a temperature fluctuation are included in addition to the zero point bias when the output of the sensor is zero. For this reason, when the bias is strictly cancelled, it is necessary to perform the calibration whenever the power source is activated and the sensor begins to be used. The calibration requires a time of approximately a few seconds to a few dozen seconds. In addition, the calibration usually allows a user to make the sensor have a predetermined movement (for example, stopping, rotating, or the like) as a predetermined posture. For this reason, when the calibration is performed with respect to a device which is normally used, the calibration imposes a burden on the user.

In addition, even when the calibration is performed, it is not possible to eliminate a bias included in a sensor detection value by performing complete calculation, and thus a small error may be included in the inertial navigation arithmetic result.

### SUMMARY

An advantage of some aspects of the invention is to propose a new method of maintaining measurement accuracy to a constant degree without needing frequent calibration.

A first aspect of the invention is directed to a position calculation method including executing first position calculation processing which estimates and updates an error index value relevant to a detection value of a predetermined sensor for position calculation by using a detection result of the sensor, and calculates a current position; storing environment information at the time of calculating the first position calculation processing; and executing second position calculation processing which sets an initial error index value at the time of newly performing the position calculation on the basis of a difference between environment information at the time of newly performing the position calculation and the stored environment information, estimates and updates the error index value by using the detection result of the sensor, and calculates a current position.

As another aspect of the invention, the first aspect of the invention may be configured as a position calculation device including a predetermined sensor for position calculation; a position calculation unit which estimates and updates an error index value relevant to a detection value of the sensor, and calculates a current position; and a setting unit which stores environment information at the time of performing previous position calculation by the position calculation unit in a storage unit, and sets an initial error index value at the time of newly performing the position calculation on the basis of a difference between environment information at the time of newly performing the position calculation by the position calculation unit and the environment information stored in the storage unit.

According to the first aspect and the like of the invention, it is possible to set the initial error index value relevant to the detection value of the sensor on the basis of the difference between the environment information at the time of newly performing the position calculation and the environment information at the time of the previous calculation. The detection result of the sensor is affected by the environment. For this reason, the error index value is set according to an environment change from the previous calculation, and thus it is possible to reduce an error relevant to the detection value. Accordingly, it is possible to maintain measurement accuracy to a constant degree without executing the calibration.

A second aspect of the invention is directed to the position calculation method of the first aspect of the invention, wherein the first position calculation processing and the second position calculation processing are processing which calculates a current position by using a Kalman filter using an error covariance matrix based on the error index value.

According to the second aspect of the invention, as the position calculation processing, the current position is calculated by using the Kalman filter using the error covariance matrix based on the error index value.

A third aspect of the invention is directed to the position calculation method of the first or second aspect of the invention, wherein the setting the error index value includes setting the initial error index value at the time of newly performing the position calculation to an error index value indicating a predetermined maximum error when the difference between the environment information at the time of newly performing the position calculation and the stored environment information does not satisfy predetermined acceptable difference conditions, and the sensor is not calibrated.

According to the third aspect of the invention, it is possible to set the initial error index value at the time of newly performing the position calculation to the error index value indicating the predetermined maximum error when the difference in the environment information does not satisfy the predetermined acceptable difference conditions, and the sensor is not calibrated.

A fourth aspect of the invention is directed to the position calculation method of the third aspect of the invention, wherein the executing the second position calculation processing includes performing the position calculation by setting a bias error of the sensor to zero when the initial error index value is the error index value indicating the maximum error.

According to the fourth aspect of the invention, the position calculation is performed by setting the bias error of the sensor to zero when the initial error index value is the error index value indicating the maximum error.

A fifth aspect of the invention is directed to the position calculation method of any one of the first to fourth aspects of the invention, wherein the environment information includes information of an environmental temperature of the sensor, and the setting the error index value includes variably setting the error index value according to a difference between an environmental temperature at the time of newly performing the position calculation and the stored environmental temperature.

According to the fifth aspect of the invention, the environment information includes information of the environmental temperature of the sensor, and the error index value is variably set according to the difference between the current environmental temperature and the previous environmental temperature. For example, it is possible to set the error index value to a value indicating that the error increases as the difference in the environmental temperature becomes larger.

A sixth aspect of the invention is directed to the position calculation method of any one of the first to fifth aspects of the invention, wherein the storing includes storing calculated date and time of the first position calculation processing, and the setting the error index value includes variably setting the error index value according to a difference between the date and time at the time of newly performing the position calculation and the stored calculated date and time.

According to the sixth aspect of the invention, the environment information includes the calculated date and time, and the error index value is variably set according to the difference between the currently calculated date and time and the previously calculated date and time. For example, it is possible to set the error index value to a value indicating that the error increases as the difference in the calculated date and time becomes larger.

### BRIEF DESCRIPTION OF THE DRAWINGS

The invention will be described with reference to the accompanying drawings, wherein like numbers reference like elements.

FIG. 1 is a configuration example of a position calculation device.

FIG. 2 is a functional configuration diagram of the position calculation device.

FIG. 3 is a flowchart of position calculation processing.

### DESCRIPTION OF EXEMPLARY EMBODIMENTS

### System Configuration

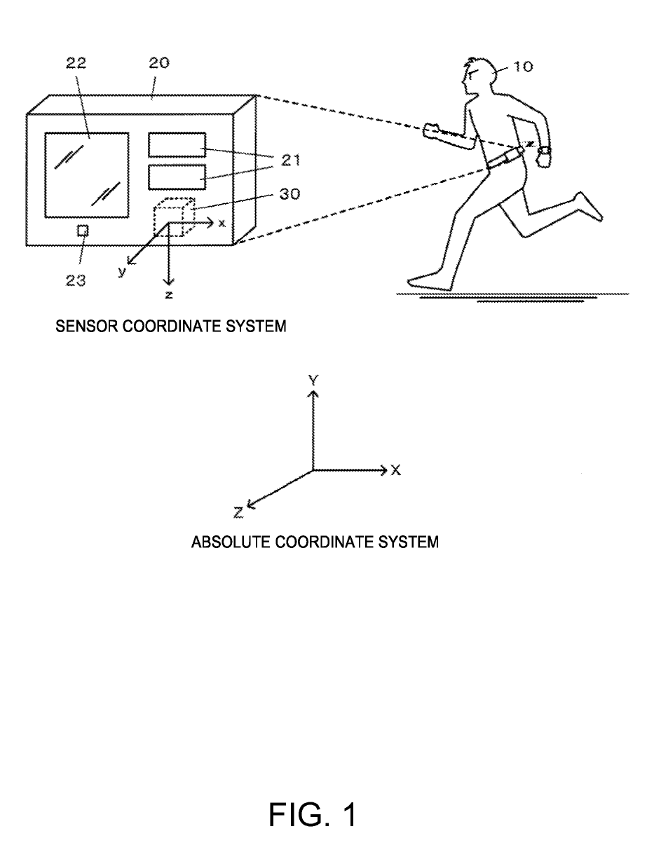

FIG. 1 is a configuration example of a position calculation device 20 of this embodiment. The position calculation device 20, for example, is a portable electronic device which is used by being mounted on a lower back portion of a user 10 at the time of running. An operation switch 21, a display 22, a speaker 23, or the like is disposed in the position calculation device 20, and a control device (not illustrated) on which an Inertial Measurement Unit (IMU) 30, a Central Processing Unit (CPU), and a memory are mounted is embedded in the position calculation device 20.

The IMU 30 is an inertial sensor unit including a acceleration sensor and a gyro sensor. The acceleration sensor detects acceleration in a sensor coordinate system (a local coordinate system) which is a three-dimensional orthogonal coordinate system (x, y, z) associated with the sensor. The gyro sensor detects an angular velocity in a sensor coordinate system which is a three-dimensional orthogonal coordinate system (x, y, z) associated with the sensor.

Furthermore, it is described that the sensor coordinate system of the acceleration sensor and the sensor coordinate system of the gyro sensor have the same coordinate axis, but when the coordinate axes are different from each other, one coordinate system is able to be converted into the other coordinate system by performing coordinate conversion matrix arithmetic. A known method may be applied to the coordinate conversion matrix arithmetic.

The position calculation device 20 performs inertial navigation arithmetic using a detection value of the IMU 30, and thus it is possible to calculate the position, the velocity, the posture, or the like of the device.

However, a large error may occur in an inertial navigation arithmetic result according to a bias included in an output value of each sensor (the acceleration sensor, and the gyro sensor) of the IMU 30. For this reason, it is necessary that the bias of each sensor of the IMU 30 is calculated (estimated) in advance, and the inertial navigation arithmetic is performed in consideration of the calculated bias. As a calculation method of the bias in the related art, for example, calibration is performed in which the bias of each sensor of the IMU 30 is calculated (estimated) and amended at the time of starting the use of the device immediately after a power source is activated. In this embodiment, it is determined whether or not the calibration is necessary on the basis of a difference with respect to the environment of the previous use, and when it is determined that the calibration is necessary, the calibration is performed, and when it is determined that the calibration is not necessary, the bias of the previous use is directly used.

In addition, Kalman filter processing is used in position calculation of the inertial navigation arithmetic, and an initial value of an error covariance matrix which is an error index value used in the Kalman filter processing is set according to the difference with respect to the environment of the previous use.

### Functional Configuration

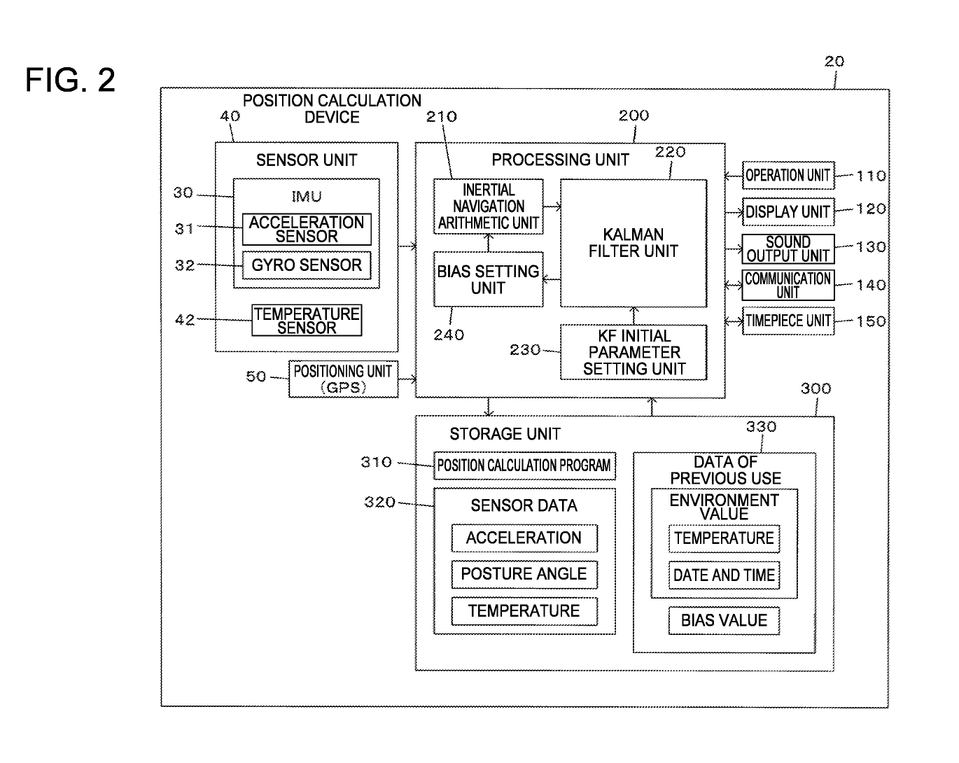

FIG. 2 is a functional configuration diagram of the position calculation device 20. According to FIG. 2, the position calculation device 20 includes a sensor unit 40, a positioning unit 50, an operation unit 110, a display unit 120, a sound output unit 130, a communication unit 140, a timepiece unit 150, a processing unit 200, and a storage unit 300.

The sensor unit 40 includes the IMU 30 which is a predetermined sensor for position calculation, and a temperature sensor 42 which is an environment sensor. The IMU 30 includes an acceleration sensor 31, and a gyro sensor 32. A detection value of each sensor (the acceleration sensor 31, the gyro sensor 32, and the temperature sensor 42) of the sensor unit 40 is output to the processing unit 200, and is stored as sensor data 320.

The positioning unit 50 is a unit for performing positioning by using a satellite positioning system, and includes a receiving antenna receiving a satellite signal which is transmitted from a positioning satellite, a Radio Frequency (RF) circuit processing the received signal, a baseband processing circuit, and the like. For example, the positioning unit 50 is realized by a Global Positioning System (GPS) unit.

The operation unit 110, for example, is realized by an input device such as a touch panel or a button switch, and outputs an operation signal according to a performed operation to the processing unit 200. The operation switch 21 of FIG. 1 corresponds to the operation unit 110. The display unit 120, for example, is realized by a display device such as a Liquid Crystal Display (LCD), and performs various displays based on a display signal from the processing unit 200. The display 22 of FIG. 1 corresponds to the display unit 120. The sound output unit 130, for example, is realized by a sound output device such as a speaker, and performs various sound outputs based on a sound signal from the processing unit 200. The speaker 23 of FIG. 1 corresponds to the sound output unit 130.

The communication unit 140 is realized by a wireless communication device such as a wireless Local Area Network (LAN) or Bluetooth (registered trademark), and is in communication with an external device. The timepiece unit 150 is an internal timepiece of the position calculation device 20, is configured of an oscillation circuit including a quartz oscillator or the like, and outputs a time signal such as a counted current time, and an elapsed time from a designated timing to the processing unit 200.

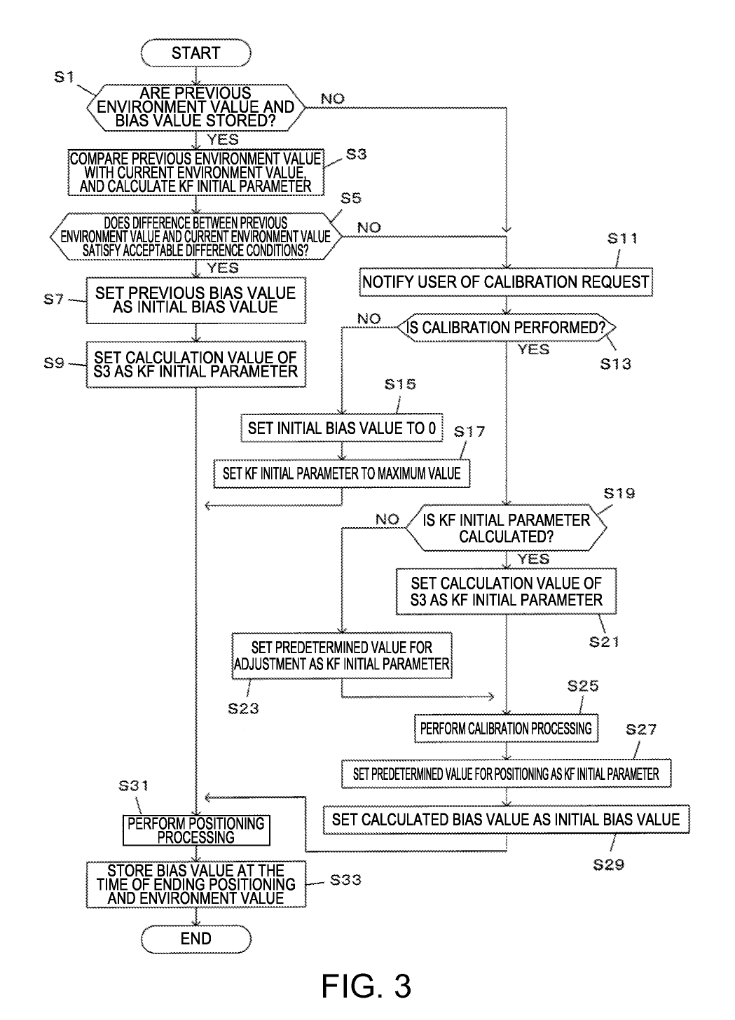

The processing unit 200, for example, is realized by an arithmetic device such as a CPU, and performs the entire control with respect to the position calculation device on the basis of a program or data stored in the storage unit, the operation signal from the operation unit, and the like. In addition, the processing unit 200 includes an inertial navigation arithmetic unit 210, a Kalman filter unit 220, a KF initial parameter setting unit 230, and a bias setting unit 240, and executes position calculation processing (refer to FIG. 3) according to a position calculation program 310. The processing unit 200 is a function unit corresponding to a position calculation unit and a setting unit. Specifically, the inertial navigation arithmetic unit 210 and the Kalman filter unit 220 correspond to the position calculation unit, and the KF initial parameter setting unit 230 and the bias setting unit 240 correspond to the setting unit.

The inertial navigation arithmetic unit 210 performs known inertial navigation arithmetic using the detection value of the IMU 30 (the acceleration obtained by the acceleration sensor 31, and the angular velocity obtained by the gyro sensor 32), and calculates the position, the velocity, and the posture angle of the device in an absolute coordinate system (X, Y, Z). In addition, in the inertial navigation arithmetic, the detection value of the IMU 30 corrected with a bias value which is set by the bias setting unit 240 is used.

The Kalman filter unit 220 performs arithmetic processing (the Kalman filter processing) based on the Kalman filter theory, and calculates the position, the velocity, the posture angle, or the like of the device. Specifically, the position, the velocity, and the posture angle obtained by the inertial navigation arithmetic unit 210 are set to a control input U, the position and the velocity obtained by the positioning unit 50 are set to an observation amount Z, and the position, the velocity, and the posture angle are set to a state X. Then, prediction arithmetic (time update) and correction arithmetic (observation update) of the Kalman filter are repeated, and an estimation value of the state X (a state estimation value) is calculated while estimation updating is performed with respect to an error covariance matrix P which is an index value of an error in each component of the state X.

The KF initial parameter setting unit 230 sets an initial value (hereinafter, referred to as a “KF initial parameter”) of the error covariance matrix P which is one of various parameters used in the Kalman filter processing performed by the Kalman filter unit 220. Specifically, the KF initial parameter is set according to a difference between an environment value of the previous execution of the position calculation processing which is the last processing in the previous use of the device (hereinafter, simply referred to as “previous use”) and an environment value of new execution of the position calculation processing by newly using the device in the current time (hereinafter, simply referred to as “current use”). For example, the KF initial parameter is set to a value having a large acceptable degree of error as a date and time difference becomes larger or as a temperature difference becomes larger. In addition, when the difference does not satisfy acceptable difference conditions described later, and the calibration is not performed, the KF initial parameter is set to a value having a maximum acceptable degree of error.

The bias setting unit 240 sets the bias of the IMU 30. Specifically, it is determined whether or not the difference between the environment value of the previous use and the environment value of the current use satisfies predetermined acceptable difference conditions. The environment values are a temperature, and date and time. The temperature is detected by the temperature sensor 42, and the date and time is counted by the timepiece unit 150. The environment value of the previous use is stored as data of previous use 330. The acceptable difference conditions are conditions in which a change in the environment is considered to be small, and for example, are defined as “the date and time difference is within 30 days”, and “the temperature difference is within 15C”.

When the difference satisfies the acceptable difference conditions, a bias value of the previous use is directly set as a bias value of the current use. The bias value of the previous use is stored as the data of previous use 330. When the difference does not satisfy the acceptable difference conditions, the calibration is performed, and a bias value obtained by the calibration is set. In addition, when the difference does not satisfy the acceptable difference conditions, and the calibration is not performed, the bias value is set to “0”.

The calibration, for example, is performed as follows. That is, the user is designated such that the device is mounted on the user at a predetermined posture (for example, a posture in which a z axis of the sensor coordinate system is in a directly downward direction), a predetermined operation (for example, standing still, rotating on site (rotating in a clockwise direction or in a counterclockwise direction), or the like) is performed by displaying a predetermined message on the display unit 120 or the like, and at this time, the bias of each sensor of the IMU 30 is calculated on the basis of the position, the velocity, and the posture angle calculated by the Kalman filter unit 220. A known technology is able to be applied to the calibration its elf.

The storage unit 300 is realized by a storage device such as a Read Only Memory (ROM) or a Random Access Memory (RAM), stores a program, data, or the like by which the processing unit 200 comprehensively controls the position calculation device 20 and is used as a work area of the processing unit 200, and temporarily stores an arithmetic result executed by the processing unit 200 according to various programs, a detection value from the sensor unit 40, and the like. In this embodiment, the position calculation program 310, the sensor data 320, and the data of previous use 330 are stored in the storage unit 300.

### Processing Flow

FIG. 3 is a flowchart illustrating a flow of the position calculation processing. The processing is started after the power source of the device is activated, and is executed by the processing unit 200 according to the position calculation program 310.

First, the processing unit 200 determines whether or not the environment value and the bias value of the previous use (hereinafter, comprehensively referred to as a “value of previous use”) are stored. When the value of previous use is stored (Step S1: YES), the KF initial parameter setting unit 230 calculates a current KF initial parameter according to the difference between the stored environment value of the previous use and the environment value of the current use (Step S3).

Next, it is determined whether or not the difference between the environment value of the previous use and the environment value of the current use satisfies the predetermined acceptable difference conditions. When the difference satisfies the acceptable difference conditions (Step S5: YES), the bias setting unit 240 sets the stored bias value of the previous use in the inertial navigation arithmetic unit 210 as the bias value of the current use (Step S7). In addition, the KF initial parameter setting unit 230 sets the KF initial parameter calculated in Step S3 in the Kalman filter unit 220 as the current KF initial parameter (Step S9).

In contrast, when the previous value is not stored (Step S1: NO), or when the difference does not satisfy the acceptable difference conditions (Step S5: NO), the processing unit 200 asks the user whether or not to perform the calibration by displaying a predetermined message on the display unit 120 or the like (Step S11), and determines whether or not to perform the calibration according to the operation input of the user.

When the calibration is not performed (Step S13: NO), the bias setting unit 240 sets the initial bias value in the inertial navigation arithmetic unit 210 as “0” (Step S15). In addition, the KF initial parameter setting unit 230 sets the KF initial parameter in the Kalman filter unit 220 as a predetermined maximum value which maximizes the acceptable degree of error (Step S17).

In contrast, when the calibration is performed (Step S13: YES), the KF initial parameter setting unit 230 determines whether or not the current KF initial parameter is calculated (whether or not Step S3 is executed). When the calculation is performed (Step S19: YES), the KF initial parameter calculated in Step S3 is set in the Kalman filter unit 220 as the current KF initial parameter (Step S21). When the calculation is not performed (Step S19: NO), an initial value for adjustment which is a parameter value for predetermined calibration is set in the Kalman filter unit 220 as a new KF initial parameter (Step S23).

After that, the bias setting unit 240 performs calibration processing (Step S25), and sets the bias value calculated by the calibration in the inertial navigation arithmetic unit 210 as the current bias value (Step S27). In addition, the KF initial parameter setting unit 230 sets a parameter value for predetermined positioning in the Kalman filter unit 220 as the new KF initial parameter (Step S29).

After Step S9 or Step S29, the processing unit 200 performs positioning processing (Step S31). In the positioning processing, the position and the velocity calculated by the Kalman filter unit 220 are positioning results. When the positioning processing is ended, the processing unit 200 stores a bias value at the time of ending the positioning processing and a current environment value in the storage unit 300 as a previous value (Step S33). When the processing described above is performed, the position calculation processing is ended.

### Functional Effect

Thus, according to the position calculation device 20 of this embodiment, when the difference between the environment value of the previous use and the environment value of the current use satisfies the predetermined acceptable difference conditions, the bias value of the previous use is used without needing the calibration and an initial value of an error covariance which is the error index value is set according to the difference between the environment value of the previous use and the environment value of the current use, and the inertial navigation arithmetic using the Kalman filter is performed. Accordingly, it is possible to maintain measurement accuracy to a constant degree without executing the calibration.

### COMPARATIVE EXAMPLE

Furthermore, an embodiment to which the invention is able to be applied is not limited to the embodiment described above, and the embodiment is able to be suitably changed without departing from the spirit of the invention.

For example, a setting destination of the bias of the bias setting unit 240 is described as the inertial navigation arithmetic unit 210, but the Kalman filter unit 220 may be the setting destination of the bias. That is, a sensor bias of the IMU 30 (an acceleration bias, and an angular velocity bias) may be included in the element of the state X in the Kalman filter processing, and the value of the sensor bias may be a value set by the bias setting unit 240.

In addition, the acceptable difference conditions are the temperature and the date and time, but may be only one of them, or may be others.

In addition, the element of the state X in the Kalman filter processing is an example, and other elements may be the state X.

The entire disclosure of Japanese Patent Application No. 2014-156117, filed Jul. 31, 2014 is expressly incorporated by reference herein.

What is claimed is:

1. A position calculation method, comprising:
executing first position calculation processing which estimates and updates an error index value relevant to a detection value of a sensor by using the detection value of the sensor, and calculates a position at a first time point;
storing environment information at the time of calculating the first position calculation processing; and
executing second position calculation processing which sets an initial error index value at the time of performing position calculation at a second time point later than the first time point on the basis of a difference between environment information at the second time point and the stored environment information at the first time point, estimates and updates the error index value by using the detection result of the sensor, and calculates a position at the second time point.

2. The position calculation method according to claim 1,
wherein the first position calculation processing and the second position calculation processing are processing which calculates a position by using a Kalman filter using an error covariance matrix based on the error index value.

3. The position calculation method according to claim 1, further comprising:
setting the initial error index value at the time of performing the position calculation at the second time point to an error index value indicating a predetermined maximum error when the difference between the environment information at the second time point and the environment information at the first time point does not satisfy predetermined acceptable difference conditions, and the sensor is not calibrated.

4. The position calculation method according to claim 3, further comprising:
performing the position calculation at the second time point by setting a bias error of the sensor to zero when the initial error index value is the error index value indicating the maximum error.

5. The position calculation method according to claim 1,
wherein the environment information includes information of an environmental temperature of the sensor, and
the setting the error index value includes variably setting the error index value according to a difference between an environmental temperature at the second time point and an environmental temperature at the first time point.

6. The position calculation method according to claim 1,
wherein the storing includes storing calculated date and time of the first position calculation processing, and
the setting the initial error index value includes variably setting the initial error index value according to a difference between the date and time at the time of newly performing the position calculation and the stored calculated date and time.

7. A position calculation device, comprising:
a sensor;
a position calculation unit which estimates and updates an error index value relevant to a detection value of the sensor, and calculates a position at a first time point; and
a setting unit which stores environment information at the time of performing position calculation at the first time point by the position calculation unit in a storage unit, and sets an initial error index value at the time of performing the position calculation at a second time point later than the first time point on the basis of a difference between environment information at the time of performing the position calculation at the second time point and environment information at the first time point stored in the storage unit.
